(19) United States
(12) Patent Application Publication
(10) Pub. No.: US 2009/0254308 A1
(43) Pub. Date: Oct. 8, 2009

(54) Method for Automatic Monitoring of Generator Operation

(76) Inventor: Christoph Lehmann, Neukirchen-Vluyn (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/084,303

(22) PCT Filed: Oct. 24, 2006
(86) PCT No.: PCT/EP2006/067714

§ 371 Date: May 8, 2009

(30) Foreign Application Priority Data
Oct. 31, 2005 (EP) 05023759.3

(51) Int. Cl. G06F 15/00

(52) U.S. Cl. 702/182

(57) ABSTRACT

The invention relate to a method for automatic monitoring of generator operation, which method has the following steps: recording of generator input variables, calculation of set generator output variables based on the recorded generator input variables, recording of the actual generator output variables, comparison of the recorded actual generator output variables with the calculated set generator output variables, and evaluation of the comparison results.

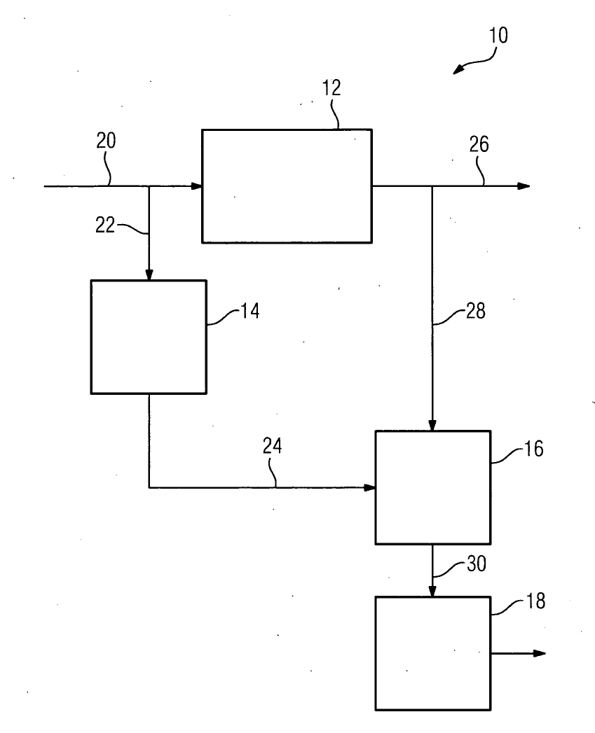

### CROSS REFERENCE TO RELATED APPLICATIONS

This application is the US National Stage of International Application No. PCT/EP2006/067714, filed Oct. 24, 2006 and claims the benefit thereof. The International Application claims the benefits of European application No. 05023759.3 filed Oct. 31, 2005, both of the applications are incorporated by reference herein in their entirety.

### FIELD OF INVENTION

The present invention relates to a method for automatic monitoring of generator operation, and to a corresponding monitoring system.

### BACKGROUND OF THE INVENTION

Generators, that is to say devices which produce electrical energy from energy with motion, are generally known in the prior art. A torque which is applied to the generator shaft rotates a coil in the interior of the generator, in a magnetic field which can be excited by the dynamo-electrical principle and produces electrical voltage by induction. When a load is connected to the generator, an electric current then flows.

Large generators essentially comprise a stator, a rotor and bearing blocks which hold the rotor. Mechanical power is supplied to the rotor via its shaft, for example from a turbine or from an internal combustion engine, thus keeping the rotor at the operating rotation speed and rotating it within the stator, resulting in an AC voltage being produced by induction in each phase of the three-pole stator winding. Corresponding three-phase power is produced by offsetting each of the stator coils through 120°.

The generator may be in the form of a synchronous generator or an asynchronous generator. In synchronous generators, the rotor has a field winding which is supplied with direct current from the outside via sliding contacts. In the case of an asynchronous generator, on the other hand, the rotor is in the form of a squirrel-cage rotor.

During operation of generators such as these, the generator operating data may change. However, in this case, it is not immediately possible to identify whether the changes are the result of changes to constraints or a fault in the generator itself, since the generator operating data is dependent on a large number of constraints, such as the load, the power supply system data, the coolant data or the like.

In the event of major changes in the generator operating data, it is normal for the operator first of all to refer to the generator suppliers where the changed generator operating data can be analyzed by experts, in order to determine whether the generator itself has been damaged. If this is the case, the generator must be shut down for checking, and may need to be repaired. On the other hand, if the analysis shows that the generator is not itself faulty, then it is still possible to operate it. One disadvantage of this procedure is that expert analysis such as this is time-consuming and expensive.

### SUMMARY OF INVENTION

One object of the present invention is therefore to provide means which ensure that a generator need be analyzed by experts only when major changes in the generator operating data are actually caused by a fault in the generator itself.

In order to achieve this object, the present invention provides a method for automatic monitoring of generator operation as claimed in the claims, and a corresponding system as claimed in the claims. The dependent claims refer to individual refinements of the method according to the invention and of the system according to the invention.

In the method for automatic monitoring of generator operation according to the present invention, generator input variables are first of all recorded with the aid of a suitable sensor system. In the present case, the expression “generator input variables” should be understood as meaning generator operating values which define the constraints to which generator operation is subject.

These include, for example, the stator voltage, the stator current, the power supply system frequency, the stator winding temperature, the cooling water inlet temperature, the sealing oil inlet temperature or the like. The generator input variables therefore include all the external influences which can act on the generator.

Nominal generator output variables are calculated on the basis of these recorded generator input variables. The expression “generator output variables” includes those generator operating values which describe loads on the generator components, such as the stator winding temperature, the bearing temperatures, the shaft oscillation amplitudes, the end-winding oscillation amplitudes or the like. The generator output variables accordingly include all those influences which can affect the generator itself and may be the cause of a fault in the generator.

The nominal generator output variables are advantageously calculated using suitable software describing logic links between the generator input variables and the generator output variables, for example on the basis of mathematical equations. These logic links can be determined either by theoretical analyses or by appropriate measurements. For this purpose, by way of example, the generator input variables are varied when the generator is sound, and the generator output variables are observed. This makes it possible to calculate nominal generator output variables, preferably with an appropriate tolerance band.

Furthermore, according to the method according to the invention, the actual generator output variables are recorded by means of a suitable sensor system and are compared with the calculated nominal generator output variables. If the evaluation of the comparison result shows that the actual generator output variables are within the tolerance band of the nominal generator output variables, then there is obviously no fault in the generator itself.

If the actual generator output variables in contrast differ from the nominal generator output variables, then the generator is defective, and must be subjected to an appropriate examination.

One major advantage of the method according to the invention for automatically monitoring generator operation is that the generator can be automatically checked for correct operation at all of its operating points. Experiments have shown that very wide tolerance bands may be allowed for some nominal generator output variables without endangering the operation of the generator itself. In a corresponding manner, even highly fluctuating generator operating data may still be within the permissible range, which data would have resulted in the generator being subjected to an examination when using the previous procedure. Accordingly, in many cases, the method according to the invention can be used to avoid analysis of the changed generator operating data by appropriate experts, thus saving time and costs.

Furthermore, the present invention relates to a system for automatic monitoring of generator operation which can be used for carrying out the method according to the invention. The system comprises sensors for recording generator input variables, a computer unit which is designed to allow nominal generator output voltages to be calculated on the basis of generator input variables recorded by means of the sensors, sensors for recording the actual generator output variables, a comparison unit, which is designed to compare the recorded actual with the calculated nominal generator output variables, and an evaluation unit for evaluation of the comparison results. The computer unit, the comparison unit and the evaluation unit are preferably formed integrally, for example in the form of a conventional PC, which has an appropriate calculation, comparison and evaluation program.

### BRIEF DESCRIPTION OF THE DRAWINGS

An example of a refinement of the present invention will be described in more detail in the following text with reference to the attached drawing which shows, schematically, one example of a refinement of the system according to the invention.

### DETAILED DESCRIPTION OF INVENTION

The system 10 has a generator 12, a computer unit 14, a comparison unit 16 and an evaluation unit 18. Although this is not illustrated in any more detail in the drawing, the generator 12 has a solid stationary part, the stator, which in principle represents a large induction coil with an iron core, a rotor which is held on a rotor shaft, and two bearing blocks which act as bearings for the rotor shaft. The rotor is supplied with mechanical power via an internal combustion engine, which is likewise not illustrated, thus resulting in the rotor that is provided within the stator being accelerated to a predetermined operating rotation speed. The generator 12 is in the form of an asynchronous generator, and has a squirrel-cage rotor. An AC voltage is produced by induction in each phase of the three-pole stator winding. Three-phase power is produced by the rotor as it rotates in the stator, because the stator coils are each offset through 120°.

The generator 12 has generator input variables which are indicated in a combined form by the arrow annotated with the reference number 20. These input variables are generator operating values which define the constraints to which operation of the generator is subject. In the present case, the generator input variables 20 comprise the stator voltage, the stator current, the power supply system frequency, the stator winding temperature, the cooling water inlet temperature and the sealing oil inlet temperature. These generator input variables 20 are recorded by suitable sensors, with the determined generator input variables being combined by the arrow annotated with the reference number 22. The recorded generator input variables 22 are supplied to the computer unit 14. Nominal generator output variables are calculated with the aid of a suitable computer program in the computer unit 14 on the basis of the recorded generator input variables 22, with the calculated nominal generator output variables being illustrated in a combined form in the drawing by the arrow annotated with the reference number 24.

The nominal generator output variables 24 calculated in the present case comprise the nominal stator winding temperature, the nominal bearing temperatures, the nominal shaft oscillation amplitudes and the nominal end-winding oscillation amplitudes. The software to be used for calculation of the nominal generator output variables in the computer unit 14 describes the logic links between the generator input variables and the generator output variables. The logic links may be determined either by theoretical analyses or by measurements. By way of example, the logic links are defined by varying the input variables and observing the output variables when the generator is sound. This allows nominal generator output variable tolerance bands to be determined for every generator input variable combination, in which the generator 12 is considered to be serviceable.

The generator output variables, which are represented by the arrow annotated with the reference number 26, may be recorded at the generator 12 by appropriate sensors. The actual generator output variables recorded in this way are represented in the drawing by the arrow annotated with the reference number 28. In this case, the expression generator output variables should be understood as meaning the generator operating variables which describe the loads of the generator components and may lead to a fault in the generator 12. The actual generator output variables 28 recorded in the present case are the actual stator winding temperature, the actual bearing temperatures, the actual shaft oscillation amplitudes and the actual end-winding oscillation amplitudes.

Both the calculated nominal generator output variables 24 and the recorded actual generator output variables 28 are supplied to the comparison unit 16, in which they are compared with one another.

The comparison result, which is represented by the arrow annotated with the reference number 30, is then supplied to the evaluation unit 18, which determines whether the difference between the recorded actual generator output variables 28 and the calculated nominal generator output variables 24 is still within the defined tolerance bands. If this is the case, then the generator 12 is sound, so that operation of the generator 12 can be continued without any problems. In contrast, if the recorded actual generator output variables 28 do not correspond to the calculated nominal generator output variables 24, then it can be assumed that the generator 12 has been damaged in some way, and an examination of the generator is then initiated.

The computer unit 14, the comparison unit 16 and the evaluation unit 18 are illustrated as mutually independent units in the drawing, in order to make the illustration clearer. It is, of course, also possible for them to be integrated in a common unit.

It should be obvious that the example of a refinement of the system 10 according to the invention as illustrated in the drawing as well as the method according to the invention explained on the basis of this example of the system 10 are not restrictive. In fact, modifications and changes are possible without departing from the scope of protection of the present invention as defined by the attached claims.

1.-7. (canceled)

8. A method for automatic monitoring of generator operation, comprising:
recording a plurality of generator input variables;
calculating a plurality of nominal generator output variables, based on the recorded generator input variables with the aid of logic links between the generator input variables and the generator output variables, where the logic links are determined by theoretical analyses or measurements;
recording the actual generator output variables that correspond to the plurality of the calculated nominal generator output variables;
comparing the recorded actual with the calculated nominal generator output variables; and
evaluating the comparison results.

9. The method as claimed in claim 8, wherein the generator input variables are selected from the group consisting of: the stator voltage, the stator current, the power supply system frequency, the stator winding temperatures, the cooling water temperature, the sealing oil inlet temperature, and combinations thereof.

10. The method as claimed in claim 9, wherein the generator output variables are selected from the group consisting of: the stator winding temperatures, the bearing temperatures, the shaft oscillation amplitudes, the end-winding oscillation amplitudes, and combinations thereof.

11. The method as claimed in claim 10, wherein the nominal generator output variables are calculated using suitable software.

12. The method as claimed in claim 11, wherein at least some of the nominal generator output variables have a tolerance band.

13. A system for automatic monitoring of generator operation, comprising:
a plurality of generator input variable sensors that record a plurality of generator input variables;
a computer unit calculate nominal generator output variables based on generator input variables recorded by the sensors, wherein the nominal generator output variables are calculated with the aid of logic links, and with the logic links are determined by theoretical analyses or measurements;
a plurality of actual generator output variable sensors that record a plurality of actual generator output variables;
a comparison unit that compares the recorded actual generator output variables with the calculated nominal generator output variables; and
an evaluation unit that evaluates the comparison results.

14. The system as claimed in claim 13, wherein the computer unit, the comparison unit and the evaluation unit are formed integrally.
